(19) United States
(12) Patent Application Publication
(10) Pub. No.: US 2015/0347376 A1
(43) Pub. Date: Dec. 3, 2015

(54) SERVER-BASED PLATFORM FOR TEXT PROOFREADING

(71) Applicant: Golden Board Cultural and Creative Ltd., Co., Taipei City (TW)

(72) Inventors: Yin-Hao Tsui, Taipei City (TW); Chen-Li Hsieh, Taipei City (TW)

(21) Appl. No.: 14/700,213

(22) Filed: Apr. 30, 2015

(30) Foreign Application Priority Data
May 30, 2014 (TW) 103209687

(51) Int. Cl. G06F 17/27; G06F 17/24

(52) U.S. Cl. CPC G06F 17/274; G06F 17/24

(57) ABSTRACT

A server-based platform for text proofreading includes a network unit, a processing unit, and a storing unit. The network unit connects to a networking device to receive a document including original paragraphs with words. The processing unit connects electronically to the network unit for identifying the words from the document, converting the words into reflow paragraphs, and generating an index data based on the contrast relationship between the original paragraphs and the converted reflow paragraphs. The storing unit connects electronically to the processing unit for storing a reflow document including the reflow paragraphs. The processing unit generates a proofread webpage including a first window and a second window. When the processing unit receives a referencing command from the networking device via the network unit, the original paragraphs and the corresponding reflow paragraphs are displayed on the first window and the second window respectively according to the index data.

### CROSS-REFERENCES TO RELATED APPLICATIONS

This non-provisional application claims priority under 35 U.S.C. §119(a) on Patent Application No. 103209687 filed in Taiwan, R.O.C. on 2014/05/30, the entire contents of which are hereby incorporated by reference.

### BACKGROUND

1. Technical Field

The present invention is related to a server, especially to a server-based platform for text proofreading.

2. Related Art

As technology has developed, handheld-devices (such as PAD devices or mobile phones), have become very common in everyday life. People use these handheld-devices to browse websites and read e-books. Consequently, the demand of e-books has increased significantly, prompting publishers to consider facilitating electronic publishing in addition to producing traditional physical paper books.

Typically, e-book files are usually made by converting physical books, which use unstructured files (such as PDF files). These files can display the contents on handhelds; however, when viewers wish to view specific content more clearly (especially when using a small display such as a smart phone display), they can only use the zoom function. It may be inconvenient when dragging the portion to zoom in/out and viewing other portions at the same time.

Some publishers may further process unstructured files using the existing conversion system to convert the unstructured files into a reflow content structured file (such as HTML file). However, the existing conversion system cannot convert files correctly, and most of the converted files cannot be adapted for use. Consequently, the digital publishers may need to retrieve text and pictures from pages manually, and then typeset. Next the retrieved text and pictures again, wasting human resources.

### SUMMARY

Therefore, the instant disclosure provides a server-based platform for text proofreading. When a user uploads a document to be converted, the server-based platform is provided for the user to check the converted document quickly.

An embodiment of the present invention provides a server-based platform for text proofreading, which is used to connect to a networking device. The server-based platform comprises a network unit, a processing unit, and a storing unit. The network unit connects to the networking device to receive a document, wherein the document comprises a plurality of original paragraphs, and the plurality of original paragraphs comprises a plurality of words. The processing unit connects electronically to the network unit for identifying the words from the document, converting the words into a plurality of reflow paragraphs, and generating an index data based on the contrast relationship between the plurality of original paragraphs and the converted reflow paragraphs. The storing unit connects electronically to the processing unit for storing a reflow document comprising the plurality of reflow paragraphs. The processing unit executes a program to generate a proofread webpage comprising a first window and a second window, and when the processing unit receives a referencing command from the networking device via the network unit, the original paragraphs and the corresponding reflow paragraphs are displayed on the first window and the second window respectively according to the index data.

According to the server-based platform for text proofreading of the present invention, the user may check possible errors from identification very quickly, modify the errors, and save the modification. Additionally, the user may preview how the converted file would be displayed on a different device.

### BRIEF DESCRIPTION OF THE DRAWINGS

FIG. 1 is a schematic diagram showing an embodiment of a server-based platform for text proofreading according to an embodiment of the present invention;

FIG. 2 is a schematic diagram showing of an e-book conversion website architecture according to an embodiment of the present invention;

FIG. 3 is a schematic diagram showing one page content of e-book according to an embodiment of the present invention; and

FIG. 4 is a schematic diagram showing a web page for proofreading according to an embodiment of the present invention.

### DETAILED DESCRIPTION

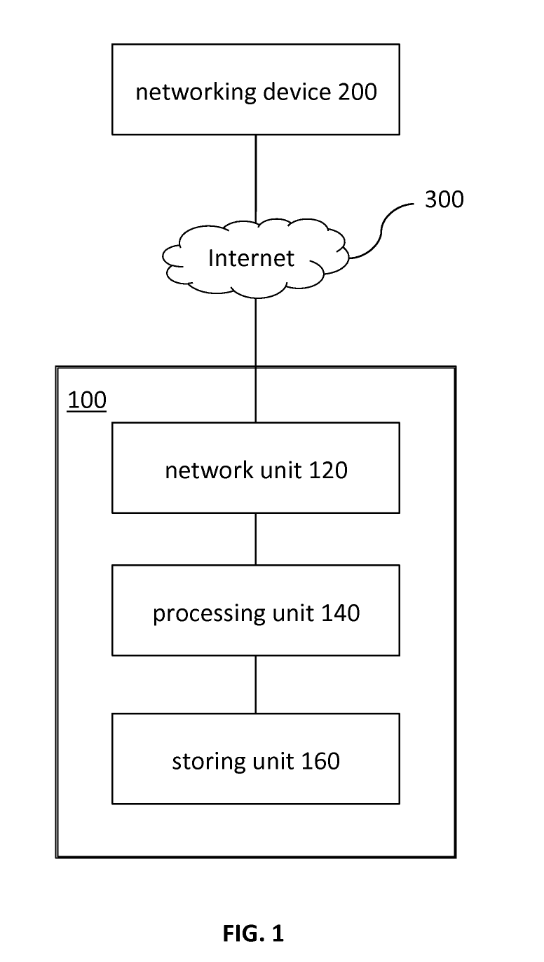

Please refer to FIG. 1, which is a schematic diagram showing an embodiment of a server-based platform for text proofreading according to an embodiment of the present invention. The server-based platform for text proofreading 100 is provided for a networking device 200 to connect with via Internet 300. The server-based platform for text proofreading 100 comprises a network unit 120, a processing unit 140 and a storing unit 160. The network unit 120 and the storing unit 160 are respectively connected to the processing unit 140. In this embodiment, the networking device 200 may be a PC, a PAD, or a smart phone, which is used by a user.

When the user finishes a book or an article, the user may use the networking device 200 to upload a document file of the book or the article via the Internet 300 to the server-based platform for text proofreading 100 for digital publishing as an e-book. The uploaded document file may be in the format compatible to the MS Word format (developed by Microsoft Company), or Portable Document Format (developed by Adobe Systems).

The network unit 120 may be a network interface card used for connecting to the Internet 300 to receive the document file uploaded from the networking device 200. The processing unit 140 may be a central process unit (CPU) for executing a program to convert the document file into reflow content document. The reflow content document can be formed in the form of an ePub file or other file, such as an html file. The storing unit 160 may be a hard disk, a memory, or other storage medium provided for storing the reflow content document and the program executed by the processing unit 140.

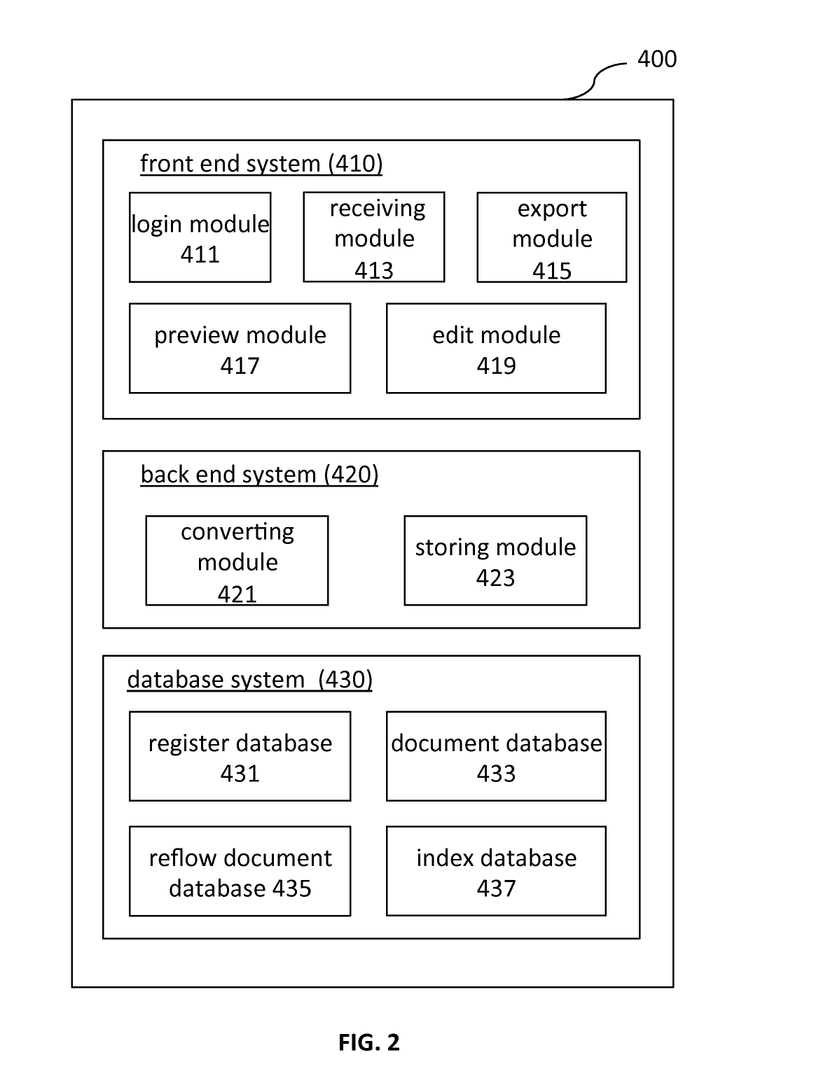

Please refer to FIG. 2, which is a schematic diagram showing of an e-book conversion website architecture 400 according to an embodiment of the present invention. The processing unit 140 may execute a program to generate a website 400. The e-book conversion website architecture 400 comprises a front end system 410, a back end system 420, and a database system 430. The front end system 410, the back end system 420, and the database system 430 are stored within the storing unit 160, wherein the front end system 410, the back end system 420 are program logic provided for the processing unit 140 to execute.

The front end system 410 comprises a login module 411, a receiving module 413, an export module 415, a preview module 417, and an edit module 419. The front end system 410 is a webpage mainly provided for the user to browse. The login module 411 may provide a register/login page for the user to register/login an account. The receiving module 413 may provide a webpage for the user to upload the document, and the receiving module 413 may further receive the uploaded document. The preview module 417 may provide a proofread webpage for the user to preview the result of the converted document. Accompanying with the edit module 419, the user may edit the proofread result. The export module 415 may export the converted and edited reflow content document to the networking device 200. The preview and edit functions will be described in detail below.

The back end system 420 comprises a converting module 421 and a storing module 423. The converting module 421 may convert the document into a reflow content document. The storing module 423 may store the converted reflow content document and/or the edited reflow content document.

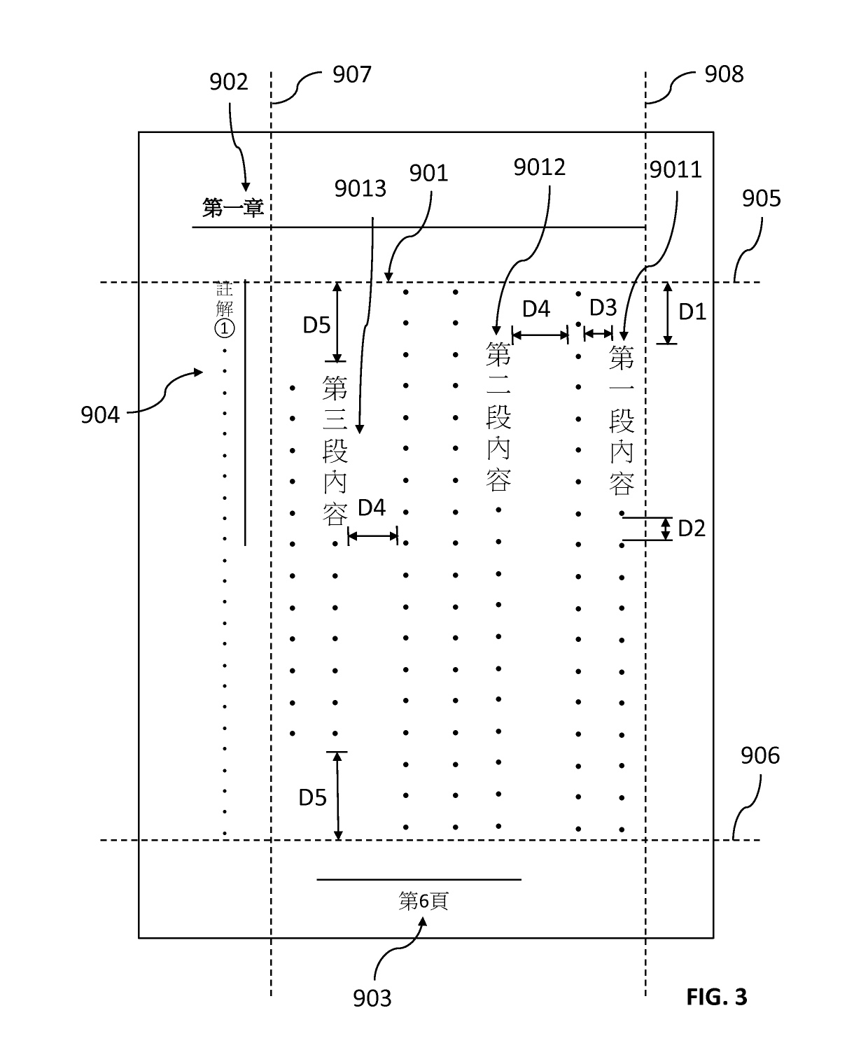

Please refer to FIG. 3, which is a schematic diagram showing one page content of the e-book. The converting process may first identify the words in every page. The page may comprises text content 901, chapter 902 located above the text layout 901, page number 903 located below the text content 901, and note 904 located on the left of the text content 901. The 2-D coordinates (i.e. ordinate and abscissa), of every word in each page are collected for determining the top edge 905, the bottom edge 906, the left edge 907, and the right edge 908. Additionally, the top edge 905 and the bottom edge 906 are decided by the most words of the ordinate, and the left edge 907 and the right edge 908 are decided by the most words of the abscissa. The note 904 shows occasionally, so it will not influence the determination of the edges. Next, the text content 901 of each page may be defined by the words located within the top edge, the bottom edge, the left edge, and the right edge. When the text content 901 is identified, the style arrangement within the text content 901 may be further identified. The style arrangement may comprise, but is not limited to, font, text size, indentation distance D1, D5, text spacing D2, and line spacing D3, D4. Normally, the text content 901 of each page may be located at the same area, and the font, text size, and stylish (such as bold or italic), of the text content 901 may be different to the text outside of area that the text content 901 is located. Consequently, it may be used to assist for determining the accurate of the edges. Finally, at least one reflow paragraph is defined by connecting words of lines in series, and an identifying confidence value of each corresponding reflow paragraph is calculated. The identifying confidence value is the probability of success for the identification based on the calculation for comprehensive assessment of various parameters. The parameters may be a degree of consistency of text style (including font, text size, text spacing, and line spacing) in the same reflow paragraph. For example, the higher degree of consistency of text style in the same reflow paragraph, the higher identifying confidence value.

In order to identify every original paragraph within the page including which lines, it may first detect the indentation distance D1. Next the reflow paragraph corresponding to the text content is typeset according to the indentation distance of the original paragraph. That is, the indented line is as the first line of the reflow paragraph, and the words before the original paragraph are connected in series to form the reflow paragraph. However, the present invention is not limited to the embodiment; for example, each original paragraph may be identified according to the difference of the line spacing D3 and D4. As shown in FIG. 3, page 6 of the article 901 includes a first paragraph 9011, a second paragraph 9012, and a third paragraph 9013. The line spacing D4 between the last line of the first paragraph 9011 and the first line of the second paragraph 9012 is different to the line spacing between lines of the paragraphs. Thus the difference of the line spacing D3 and D4 may be used to identify the lines comprised in the original paragraph and connected to the corresponding lines in series to form the reflow paragraph. The above mentioned indentation distance is not limited to the first line, which may be located in the whole paragraph (such as the indentation distance D5).

The corresponding paragraph before and after converting may be recorded by the converting module 421 for the user to reference. For example, an index data may be generated according the contrast relationship between the original paragraph and the converted reflow paragraph. The index data may comprise page numbers, line numbers, and number of words of the original paragraph in the document, or the index data may comprise coordinate position, width, and height. The index data may further comprise numbers of paragraph of the reflow paragraph.

Please refer again to FIG. 2. The database system 430 comprises a register database 431, a document database 433, a reflow document database 435, and an index database 437. The register database 431 stores every user's account information. The document database 433 stores document(s) uploaded by the user of every account. The reflow document database 435 stores reflow document(s) that is converted from the uploaded document. The index database 437 stores index data corresponding to every document (or reflow document).

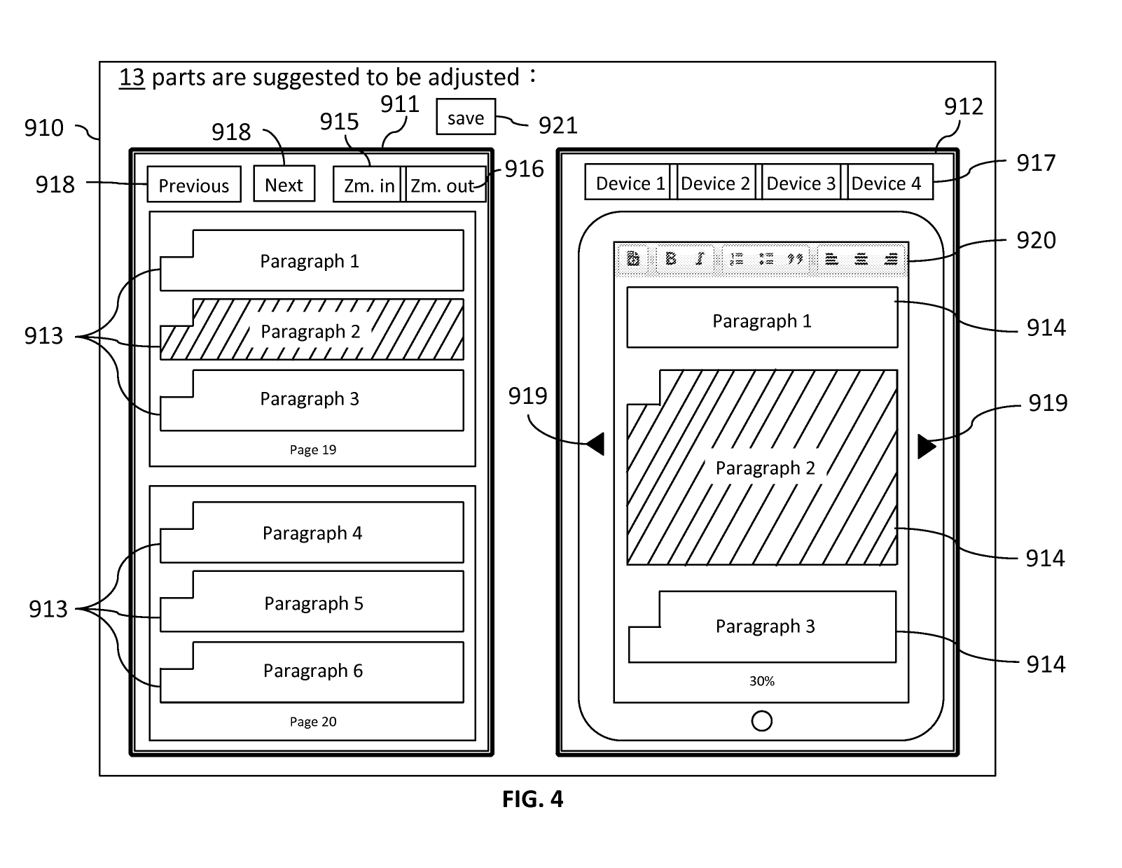

Please refer to FIG. 4, which is a schematic diagram showing a web page for proofreading according to an embodiment of the present invention. The preview module 417 may generate a proofread webpage 910. The proofread webpage 910 shows the texts of reflow paragraphs 914 and the remarks the reflow paragraphs 914 (as shown with hatched lines), that has an identifying confidence value lower than a threshold value.

The proofread webpage 910 juxtaposes a first window 911 and a second window 912. The first window 911 displays the original paragraphs 913 of the document. The second window 912 displays the reflow paragraphs 914 of the reflow document. During the converting process, when some reflow paragraph 914 is calculated with the identifying confidence value lower than the threshold value, the converting module 421 remarks the corresponding original paragraphs 913 on the first window 911. The remarks may be displayed with highlight, marquee, underline, or changing text color, etc. Consequently, the user may check the remarks first for the possible errors, so as to speed up the proofread process.

The proofread webpage 910 may comprise device selection buttons 917 and an edit tool set (i.e. edit tool bar), 920. The device selection buttons 917 may be provided for users to choose one of the devices for displaying the reflow paragraph 914 on the second window 912. For example, the device selection buttons 917 showing “device 1” may represent iPad™ of Apple Inc. (US); “device 2” may represent GALAXY S4 (smart phone), of Samsung Electronics Company. In other words, the different devices may have different size of display. The user may choose one of the device selection buttons 917 for displaying an e-book on a different device; that is the e-book may have different frames for displaying on different devices. The edit tool set 920 is generated by the edit module 419 for users to edit the reflow paragraph 914 displayed on the second window 912. For example, the edit comprises to adjust font, bold/italics, size, alignment, and other style or format.

As shown in FIG. 4, the proofread webpage 910 may comprise jump buttons (as shown with remark paragraph selection buttons 918 and page selection buttons 919, for example). FIG. 4 shows, for example, the reflow paragraph 914 of “paragraph 2”. If the user chooses the “Previous” from the remark paragraph selections 918, then the first window 911 and the second window 912 will display the previous reflow paragraph (such as reflow paragraph 914 of “paragraph 1”), that the identifying confidence value is lower than the threshold value. If the user chooses the “Next” from the remark paragraph selections 918, then the first window 911 and the second window 912 will display the next reflow paragraph (such as reflow paragraph 914 of “paragraph 3”), that the identifying confidence value is lower than the threshold value. In one embodiment, the remark paragraph selection buttons may be designed as a drop down menu for the user to choose, which comprise at least one paragraph number to be confirmed from those reflow paragraphs. Thus, the processing unit 140 may respond to the choosing of the remark paragraph selections and execute to display respectively on the first window 911 and the second window 912, according to the index data, for the paragraph number of the original paragraphs and the reflow paragraphs to be confirmed.

If the user chooses the left page selection button 919, the second window 912 will display the reflow paragraphs 914 that are before the content for current display (i.e. previous page); if the user chooses the right page selection button 919, the second window 912 will display the reflow paragraphs 914 that continues after the content for current display (i.e. next page). Consequently, the user may use the page selection buttons 919 to view the reflow paragraphs 914 of the second window 912 sequentially.

The proofread webpage 910 may further comprise save button 921. When the user has checked all remarked reflow paragraphs 914, he/she may presses the save button 921 for storing. In other words, the processing unit 140 may renew the reflow documents (i.e. overriding the file), according to an input event (such as keyboard input/delete word(s), or mouse choose, etc.), from the second window 912 and a trigger event (such as changing for bold, indentation, or placing in the middle), from the edit tool set 920.

When the processing unit 140 (preview module 417), receives a referencing command from the networking device 200 via the network unit 120 (receiving module 413), according to the index data, the original paragraphs and the reflow paragraphs corresponding each other will be displayed respectively on the first window 911 and the second window 912. The referencing command may be referred to a specific paragraph from the original paragraphs. The processing unit 140 (preview module 417), may execute the program to display a reflow paragraph corresponding to the specific paragraph on the second window 912 based on the index data. In other words, the second window 912 may display the reflow paragraph corresponding to the specific paragraph from the original paragraphs on the first window 911. In another aspect, the referencing command may also refer to a specific paragraph from the reflow paragraphs. The processing unit 140 (preview module 417), may execute the program to display the original paragraph corresponding to the specific paragraph based on the index data. In other words, the first window 911 may display the original paragraph corresponding to the specific paragraph from the reflow paragraphs on the second window 912.

In this embodiment, the referencing command may be a mouse event, such as a mouse right button click event or a mouse left button click event. For example, the user may operates the networking device 200 and clicks the mouse right button on the specific paragraph, so a selection button may be displayed on the proof read webpage 910 to select a specific paragraph and the corresponding original paragraph or reflow paragraph.

According to the server-based platform for text proofreading of the present invention, the user may check possible errors from identification very quickly, modify the errors, and save the modification. Additionally, the user may preview how the converted file would be displayed on a different device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A server-based platform for text proofreading, which is used to connect to a networking device, the server-based platform comprising:
a network unit connecting to the networking device to receive a document, wherein the document comprises a plurality of original paragraphs, and the plurality of original paragraphs comprises a plurality of words;
a processing unit electronically connecting to the network unit for identifying the words from the document, converting the words into a plurality of reflow paragraphs, and generating an index data based on the contrast relationship between the plurality of original paragraphs and the converted reflow paragraphs; and
a storing unit electronically connecting to the processing unit for storing a reflow document, wherein the reflow document comprises the plurality of reflow paragraphs;
wherein the processing unit execute a program to generate a proofread webpage comprising a first window and a second window, and when the processing unit receives a referencing command from the networking device via the network unit, the original paragraphs and the corresponding reflow paragraphs are displayed on the first window and the second window respectively according to the index data.

2. The server-based platform for text proofreading according to claim 1, wherein the index data comprises page numbers, line numbers, and number of words of the original paragraph in the document, and numbers of paragraph of the reflow paragraph.

3. The server-based platform for text proofreading according to claim 1, wherein the index data comprises coordinate position, width, and height of the original paragraph in the document, and numbers of paragraph of the reflow paragraph.

4. The server-based platform for text proofreading according to claim 1, wherein the referencing command is referred to a specific paragraph from the original paragraphs, and the processing unit executes the program to display a reflow paragraph corresponding to the specific paragraph based on the index data.

5. The server-based platform for text proofreading according to claim 1, wherein the referencing command is referred to a specific paragraph from the reflow paragraphs, and the processing unit executes the program to display an original paragraph corresponding to the specific paragraph based on the index data.

6. The server-based platform for text proofreading according to claim 1, the referencing command is corresponded to a mouse right button click event or a mouse left button click event.

7. The server-based platform for text proofreading according to claim 1, wherein the second window comprises an edit tool set, and the processing unit renews the reflow documents according to an input event from the second window and a trigger event from the edit tool set.

8. The server-based platform for text proofreading according to claim 1, wherein the second window comprises a plurality of device selection buttons, and the edit module is used to select one of the device selection buttons so as to display different size frames of the devices, wherein the reflow paragraphs are displayed within the frame.

9. The server-based platform for text proofreading according to claim 1, wherein the first window comprises a remark paragraph selection button comprising at least one paragraph number to be confirmed from the reflow paragraphs.

10. The server-based platform for text proofreading according to claim 9, wherein the processing unit responds to the choosing of the remark paragraph selections and execute to display respectively on the first window and the second window, according to the index data, for the paragraph number of the original paragraphs and the reflow paragraphs to be confirmed.
